(19) United States
(12) Patent Application Publication
(10) Pub. No.: US 2017/0099490 A1
(43) Pub. Date: Apr. 6, 2017

(54) CONSTRAINED INTRA-PREDICTION FOR BLOCK COPY MODE

(71) Applicant: QUALCOMM Incorporated, San Diego, CA (US)

(72) Inventors: Vadim Seregin, San Diego, CA (US); Krishnakanth Rapaka, San Diego, CA (US); Rajan Joshi, San Diego, CA (US); Cheng-Teh Hsieh, Del Mar, CA (US); Marta Karczewicz, San Diego, CA (US)

(21) Appl. No.: 15/273,514

(22) Filed: Sep. 22, 2016

Related U.S. Application Data
(60) Provisional application No. 62/236,426, filed on Oct. 2, 2015.

(51) Int. Cl. H04N 19/159; H04N 19/172; H04N 19/186; H04N 19/176

(52) U.S. Cl. CPC H04N 19/159; H04N 19/176; H04N 19/172; H04N 19/186

(57) ABSTRACT

Systems and methods are provided for video encoding and decoding using intra-block copy mode when constrained intra-prediction is enabled. In various implementations, a video encoding device can determine a current coding unit for a picture from a plurality of pictures. The video encoding device can further determine that constrained intra-prediction mode is enabled. The video encoding device can further encode the current coding unit using one or more reference samples. The one or more reference samples are determined based on whether a reference sample has been predicted using intra-block copy mode prediction without using any inter-predicted samples. When the reference sample is predicted using intra-block copy mode without using any inter-predicted samples, the reference sample is available for predicting the current coding unit. When the reference sample is predicted using intra-block copy mode using at least one inter-predicted sample, the reference sample is not available for predicting the coding unit.

### CROSS-REFERENCES TO RELATED APPLICATIONS

This application claims priority under 35 U.S.C. §119(e) of U.S. Provisional Application No. 62/236,426, filed on Oct. 2, 2015, the entirety of which is incorporated herein by reference.

### FIELD

This application is related to video coding and compression, and more specifically to techniques and systems that enable constrained intra-prediction mode with intra-block copy.

### BACKGROUND

Various video coding techniques may be used to compress video data. Video coding is performed according to one or more video coding standards. For example, video coding standards include high efficiency video coding (HEVC), advanced video coding (AVC), moving picture experts group (MPEG) coding, or the like. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions, and ITU-T H.265 (also known as high-efficiency video coding (HEVC)), including its scalable and multiview extensions SHVC and MV-HEVC, respectively.

### BRIEF SUMMARY

There is a coding mode called constrained intra-prediction (CIP). For CIP mode, HEVC version 1 indicates that intra-predicted blocks can use only intra-predicted reference samples to form a prediction. In the CIP mode, inter-predicted samples are treated as unavailable and are replaced with intra-predicted samples (e.g., using a padding process, such as copying data from one or more neighboring samples or generating samples using a predefined value) when CIP is in use. In some cases, intra-block copy blocks can be available for CIP mode, meaning that when CIP is enabled, intra-block copy and intra-blocks can be predicted using both intra-block copy and intra-coded reference samples.

In some examples, chroma interpolation can be used for intra-block copy for certain chroma formats (e.g., for a non-4:4:4 chroma format or other suitable format). In some examples, luma interpolation can be used for intra-block copy. In either of these examples, for CIP, it may not be sufficient to consider whether for an intra-block copy block, the reference samples originate from intra or intra-block copy prediction. For example, the samples used for chroma (or luma) interpolation that are located outside of the reference block can be inter-predicted, and thus can violate the CIP constraint or validity check requiring that an intra-predicted block is predicted without using inter-predicted samples.

Systems and methods of video coding using video encoders, decoders, and other coding processing devices are described herein. For example, to address the problem with chroma and luma interpolation, the intra-block copy validity check can be modified for CIP by considering not only the predicted block itself, but also the samples required for chroma or luma interpolation. The modified intra-block copy validity check can require that this combined area (prediction block plus samples for chroma or luma interpolation) has to satisfy the CIP constraint. While chroma interpolation is used as an example herein, the same modified intra-block copy validity check, and other techniques disclosed herein, is applicable for luma interpolation as well.

In various implementations, to meet the constrained intra-prediction requirement, when intra-block copy is enabled for a block, the samples being used for prediction are required to be intra-predicted samples. Alternatively or additionally, is some implementations, a type can be assigned to a block predicted using intra-block copy. Specifically, when the intra-block copy-predicted block is predicted using only intra-predicted samples, the block can be designated as Type 1, and when the intra-block copy block is predicted using at least one inter-coded sample, the block can be designated as Type 2. In these implementations, the Type 1 blocks can further be used when constrained intra-prediction is enabled.

In various implementations, a decoder can identify an intra-block copy-predicted block by examining the reference picture lists. For bi-predicted blocks, when the current picture is the same as both a first reference picture and a second reference picture, the decoder can determine that the bi-predicted block is an intra-block copy block. When at least one of the reference pictures is different from the current picture, then the decoder can determine that the bi-predicted block was inter-predicted. In the latter case, the bi-predicted block will not be used when constrained intra-prediction is enabled, while in the former case, the bi-predicted block can be used.

In various implementations, when, for a bi-predicted block, one reference picture is the same as the current reference picture and the other reference picture is different than the current picture, a decoder can convert the bi-predicted block to a uni-predicted block in order to satisfy the constrained intra-prediction requirement. The conversion may include discarding the reference picture that is not the same as the current picture.

In various implementations, a palette-coded block can have a 32×32 size, which is the same as the maximum possible transform size. The transform size can vary, however, between 8×8 and 32×32. Thus, in various implementations, when palette mode is enabled, the size of the palette can be configured to have a minimum size that is the same as the minimum transform size, and a maximum size that is the same as the maximum transform size. Configuring the palette size to conform with the transform size can improve memory utilization be avoiding having palette that are larger than the transform size.

According to at least one example, a method for encoding video data is provided that includes obtaining video data at an encoding device. The video data can include a plurality of pictures. The method further includes determining a current coding unit for a picture from the plurality of coding units. The method further includes determining that constrained intra-prediction is enabled for the current coding unit. The method further includes encoding the current coding unit using one or more reference samples. The one or more reference samples can be determined based on whether a reference sample has been predicted using intra-block copy mode prediction without using any inter-predicted samples. When the reference sample is predicted using intra-block copy mode without using any inter-predicted samples, the reference sample can be available for predicting the current coding unit. When the reference sample is predicted using intra-block copy mode using at least one inter-predicted sample, the reference sample cannot available for predicting the coding unit.

In another example, an apparatus is provided that includes a memory configured to store video data and a processor. The processor is configured to and can obtain video data at an encoding device. The video data can include a plurality of pictures. The processor is configured to and can determine a current coding unit for a picture from the plurality of pictures. The processor is configured to and can determine that constrained intra-prediction mode is enabled for the current coding unit. The processor is configured to and can encode the current coding unit using one or more reference samples. The one or more reference samples can be determined based on whether a reference sample has been predicted using intra-block copy mode prediction without using any inter-predicted sample. When the reference sample is predicted using intra-block copy mode without using any inter-predicted samples, the reference sample can be available for predicting the current coding unit. When the reference sample is predicted using intra-block copy mode using at least one inter-predicted sample, the reference sample cannot available for predicting the coding unit.

In another example, a computer readable medium is provided having stored thereon instructions that when executed by a processor perform a method that includes: obtaining video data at an encoding device. The video data can include a plurality of pictures. The method further includes determining a current coding unit for a picture from the plurality of pictures. The method further includes determining that constrained intra-prediction mode is enabled for the current coding unit. The method further includes encoding the current coding unit using one or more reference samples. The one or more reference samples can be determined based on whether a reference sample has been predicted using intra-block copy mode prediction without using any inter-predicted samples. When the reference sample is predicted using intra-block copy mode without using any inter-predicted samples, the reference sample can be available for predicting the current coding unit. When the reference sample is predicted using intra-block copy mode using at least one inter-predicted sample, the reference sample cannot available for predicting the coding unit.

In another example, an apparatus is provided that includes means for obtaining video data at an encoding device, the video data including a plurality of pictures. The apparatus further comprises means for determining a current coding unit for a picture from the plurality of pictures. The apparatus further comprises means for determining that constrained intra-prediction mode is enabled for the current coding unit. The apparatus further comprises means for encoding the current coding unit using one or more reference samples, wherein the one or more reference samples are determined based on whether a reference sample has been predicted using intra-block copy mode prediction without using any inter-predicted samples, wherein, when the reference sample is predicted using intra-block copy mode without using any inter-predicted samples, the reference sample is available for predicting the current coding unit, and wherein, when the reference sample is predicted using intra-block copy mode using at least one inter-predicted sample, the reference sample is not available for predicting the coding unit.

In some aspects, the methods, apparatuses, and computer readable medium described above further comprise assigning a first type to the reference sample when the reference sample was predicted using intra-block copy mode prediction without using any inter-predicted samples. These aspects can further include assigning a second type to the reference sample when the reference sample was predicted using intra-block copy mode prediction using at least one inter-predicted sample.

In some aspects, the methods, apparatuses, and computer readable medium described above further comprise using the current coding unit as a prediction block to predict another coding unit based. In these aspects, the current coding unit can be used based on the reference sample having been predicted using intra-block copy mode prediction without using any inter-predicted samples.

In various aspects, the current coding unit can be encoded using the reference sample when the reference sample was predicted using intra-block copy mode prediction without using any inter-predicted samples. In various aspects, the current coding unit can be encoded without using the reference sample when the reference sample was predicted using intra-block copy mode prediction using at least one inter-predicted samples.

In some aspects, the methods, apparatuses, and computer readable medium described above further comprise constraining prediction of the current coding unit to using only intra-predicted samples based on the constrained intra-prediction mode being enabled.

In various aspects, the reference sample can be predicted using chroma or luma interpolation. In various aspects, the one or more reference samples can be determined from a previously encoded region of the picture.

According to at least one example, a method for decoding video is provided that includes obtaining video data at a decoding device. The video data can include a plurality of pictures. The method further includes determining a current coding unit for a picture from the plurality of pictures. The method further includes determining that constrained intra-prediction mode is enabled for the current coding unit. The method further includes identifying the current coding unit as predicted using intra-block copy. Decoding the current coding unit can include using intra-predicted samples.

In another example, an apparatus is provided that includes a memory configured to store video data and a processor. The processor is configured to and can obtain video data at a decoding device. The video data can include a plurality of pictures. The processor is configured to and can determine a current coding unit for a picture from the plurality of pictures. The processor is configured to and can determine that constrained intra-prediction mode is enabled for the current coding unit. The processor is configured to and can identify the current coding unit as predicted using intra-block copy. Decoding the current coding unit can include using intra-predicted samples.

In another example, a computer readable medium is provided having stored thereon instructions that when executed by a processor perform a method that includes: obtaining video data at a decoding device. The video data can include a plurality of pictures. The method further includes determining a current coding unit for a picture from the plurality of pictures. The method further includes determining that constrained intra-prediction mode is enabled for the current coding unit. The method further includes identifying the current coding unit as predicted using intra-block copy. Decoding the current coding unit can include using intra-predicted samples.

In another example, an apparatus is provided that includes means for obtaining video data at a decoding device, the video data including a plurality of pictures. The apparatus further comprises means for determining a current coding unit for a picture from the plurality of pictures. The apparatus further comprises a means for determining that constrained intra-prediction mode is enabled for the current coding unit. The apparatus further comprises a means for identifying the current coding unit as predicted using intra-block copy, wherein decoding the current coding unit includes using intra-predicted samples.

In some aspects, the methods, apparatuses, and computer readable medium described above further comprise determining that the current coding unit is a bi-predicted coding unit. In these aspects, the current coding unit can predicted using a first reference picture and a second reference picture. These aspects can further comprise determining that the first reference picture is the same as the picture. These aspects can further comprise determining that the second reference picture is the same as the picture. In these aspects, The current coding unit can identified as predicted using intra-block copy based on the first reference picture and the second reference picture being the same as the picture.

In some aspects, the methods, apparatuses, and computer readable medium described above further comprise determining that the current coding unit is a bi-predicted coding unit. In these aspects, the current coding unit can be predicted using a first reference picture and a second reference picture. These aspects further include determining that the first reference picture is the same as the picture. These aspects can further include determining that the second reference picture is different from the picture. In these aspects, the current coding unit can converted from bi-predicted to uni-predicted based on the first reference picture being the same as the picture and the second reference picture being different than the picture.

In some aspects, the methods, apparatuses, and computer readable medium described above further comprise discarding the second reference picture as a reference.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a block diagram illustrating an example of a system including an encoding device and a decoding device;

FIG. 2 illustrates an example of a coded picture in which intra-block copy is used to predict a current coding unit;

FIG. 3 illustrates an example of a coded picture in which intra-block copy is being used to predict a current coding unit;

FIG. 4 illustrates an example of the relationship between reference picture lists and slices of different types;

FIG. 5 illustrates an example of the relationship between picture lists and slices of different types;

FIG. 6 illustrates an example of an index map of colors, corresponding to particular video block;

FIG. 7 illustrates an example of a process for using intra-block copy blocks with constrained intra-prediction is enabled, according to the techniques described herein;

FIG. 8 is a block diagram illustrating an example encoding device; and

FIG. 9 is a block diagram illustrating an example decoding device.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of the embodiments. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the embodiments as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s), comprising circuitry (e.g., integrated circuit(s)) may perform the necessary tasks.

As more devices and systems provide consumers with the ability to consume digital video data, the need for efficient video coding techniques becomes more important. Video coding is needed to reduce storage and transmission requirements necessary to handle the large amounts of data present in digital video data. Various video coding techniques may be used to compress video data into a form that uses a lower bit rate while maintaining high video quality.

Constrained intra-prediction (CIP) is an error-resilience feature in HEVC. For example, constrained intra-prediction provides an intra-prediction technique whereby a video encoder limits the use of neighboring blocks as reference blocks in the intra-prediction process. In some examples, when using constrained intra-prediction, the video encoder may be configured to use only intra-predicted reference samples to form a prediction for intra-predicted blocks, and to not use (i.e., exclude using) neighboring blocks or samples as reference if the neighboring blocks or samples were coded using inter-prediction. By not using inter-predicted samples as reference blocks for intra-prediction, the video encoder may create an encoded video bitstream that is more error resilient. The error-resiliency is achieved because inter-predicted blocks are more prone to error, as decoding inter-predicted blocks relies on information from previous and/or future frames, which may be lost during transmission. By not using inter-predicted blocks as reference blocks, constrained intra-prediction techniques avoid and/or limit the situations where potentially corrupted prior decoded picture data propagates errors into the prediction signal for intra predicted blocks.

One form of intra-prediction includes intra-block copy (IBC). Using redundancy in an image frame or picture, intra-block copy performs block matching to predict a block of samples (e.g., a coding unit, a prediction unit, or other coding block) as a displacement from a reconstructed block of samples in a neighboring region of the image frame. By removing the redundancy from repeating patterns of content, the intra-block copy prediction improves coding efficiency. Intra-block copy uses a prediction block from within a current video frame to predict a current video block. Blocks that have been predicted using intra-block copy thus qualify as intra-predicted blocks, and can themselves be available as prediction blocks when constrained intra-prediction is enabled.

It may not be the case, however, that a video block predicted using intra-block copy is entirely intra-predicted. Specifically, in some versions of the HEVC standard, chroma interpolation (and/or, in some cases, luma interpolation) is allowed for intra-block copy. A video encoder may use chroma (or luma) interpolation when a current video block being encoded includes a fractional motion vector, rather than an integer motion vector. The versions of the HEVC standard allow interpolation of the chroma (and/or, in some cases, the luma) pixel when a sampling format other than 4:4:4 (four luminance (Y), four chroma-blue (Cb) and four chroma-red (Cr) samples per pixel) applies. In some cases, the chroma (or luma) samples used for interpolation may be outside of the prediction block being used as a reference for intra-block copy. These chroma (or luma) samples may themselves have been inter-predicted. As a result, though a current video block is being intra-predicted using intra-block copy, in some cases the resulting prediction may be based on at least some inter-predicted samples, making the resulting prediction not strictly intra-predicted. Should a video block predicted in this way be used for predicting another intra-predicted video block, the constrained intra-prediction constraint would be violated.

In various implementations, provided are systems and methods for using video blocks predicted using intra-block copy when constrained intra-prediction is enabled. In some cases, a block predicted using intra block copy (also referred to herein as an “intra-block copy block”) may have been predicted from a prediction block, as well as chroma and/or luma samples that were outside the prediction block. In some cases, these chroma and/or luma samples may themselves have been inter-predicted, in which case the intra-block copy block does not satisfy the constrained intra-prediction requirement. In various implementations, when an encoder considers whether to use an intra-block copy block for prediction when constrained intra-prediction is enabled, the encoder can verify that both the prediction block and the chroma and/or luma samples were intra-predicted. When this is not the case, the intra-block copy block will not be used for prediction when constrained intra-prediction is enabled.

In some implementation, intra-block copy blocks may be constrained to using only intra-predicted samples, meaning that the pixels used to predict the intra-block copy block can themselves only be intra-predicted. Intra-block copy blocks predicted without this constraint, however, may have better compression efficiency. Thus, in some implementations, blocks predicted using intra-block copy can be assigned one of two types, where Type 1 is assigned to intra-block copy blocks that have been predicted using only intra-predicted samples, and Type 2 is assigned to intra-block copy blocks that have been predicted using at least one inter-predicted sample. In these implementations, the Type 1 intra-block copy blocks can be used when constrained intra-prediction is enabled, and the Type 2 blocks will not be used.

In some cases, an intra-block copy block can be identified as having been predicted using intra-block copy based on the reference pictures used to make the prediction. For example, a bi-predicted block can have two references pictures, where both reference pictures are the same as the current picture. In various implementations, a decoder can determine, based on both reference pictures being the same as the current picture, that the bi-predicted block is an intra-block copy block. In some cases, this intra-block copy block may further be used for prediction of a block when constrained intra-prediction is enabled for the block. In various implementations, constrained-intra prediction can be enabled for a block, a slice, a picture, a sequence or for some other grouping of video data. When at least one reference picture is not the same as the current picture, the decoder can determine that the bi-predicted block is actually inter-predicted. The block may then not be used for prediction of a block when constrained intra-prediction is enabled for the block.

Alternatively or additionally, in some implementations, when a bi-predicted block was predicted using one reference picture that is the same as the current picture, and one reference picture that is different from the current picture, a decoder may convert the bi-predicted block to a uni-predicted block, if possible. Additionally, the reference picture that is not the same as the current picture can be discarded. The uni-predicted block can then be used for prediction when constrained intra-prediction is enabled.

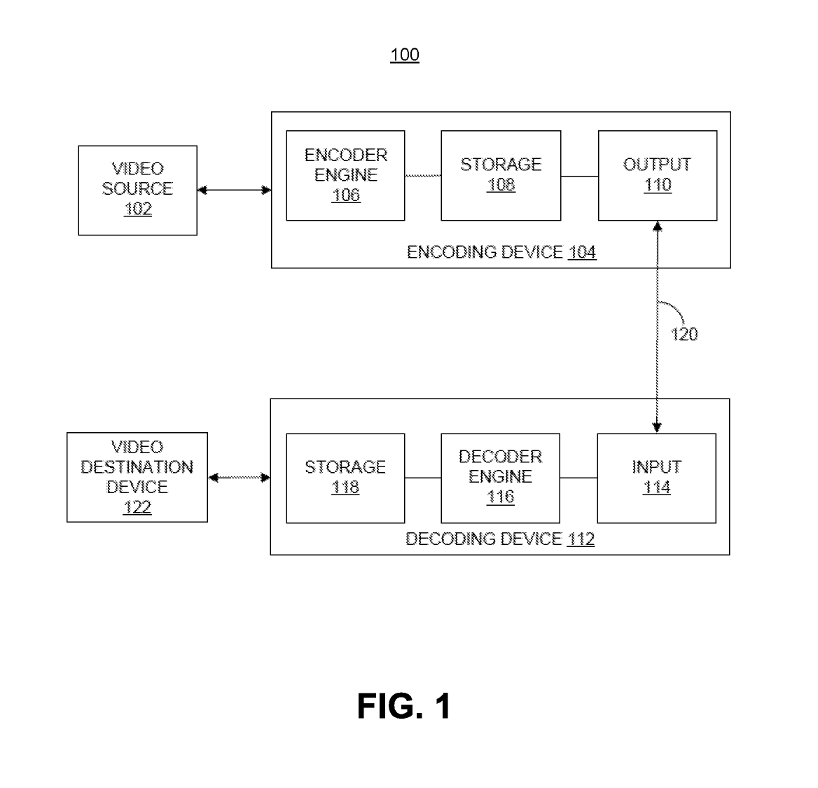

FIG. 1 is a block diagram illustrating an example of a system 100 including an encoding device 104 and a decoding device 112. The encoding device 104 may be part of a source device, and the decoding device 112 may be part of a receiving device. The source device and/or the receiving device may include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, or any other suitable electronic device. In some examples, the source device and the receiving device may include one or more wireless transceivers for wireless communications. The coding techniques described herein are applicable to video coding in various multimedia applications, including streaming video transmissions (e.g., over the Internet), television broadcasts or transmissions, encoding of digital video for storage on a data storage medium, decoding of digital video stored on a data storage medium, or other applications. In some examples, system 100 can support one-way or two-way video transmission to support applications such as video conferencing, video streaming, video playback, video broadcasting, gaming, and/or video telephony.

The encoding device 104 (or encoder) can be used to encode video data using a video coding standard or protocol to generate an encoded video bitstream. Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. Another coding standard, High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). Various extensions to HEVC deal with multi-layer video coding and are also being developed by the JCT-VC, including the multiview extension to HEVC, called MV-HEVC, and the scalable extension to HEVC, called SHVC, or any other suitable coding protocol. Further, investigation of new coding tools for screen-content material such as text and graphics with motion has been conducted, and technologies that improve the coding efficiency for screen content have been proposed. A H.265/HEVC screen content coding (SCC) extension is being developed to cover these new coding tools.

Many embodiments described herein describe examples using the HEVC standard, or extensions thereof. However, the techniques and systems described herein may also be applicable to other coding standards, such as AVC, MPEG, extensions thereof, or other suitable coding standards. Accordingly, while the techniques and systems described herein may be described with reference to a particular video coding standard, one of ordinary skill in the art will appreciate that the description should not be interpreted to apply only to that particular standard.

A video source 102 may provide the video data to the encoding device 104. The video source 102 may be part of the source device, or may be part of a device other than the source device. The video source 102 may include a video capture device (e.g., a video camera, a camera phone, a video phone, or the like), a video archive containing stored video, a video server or content provider providing video data, a video feed interface receiving video from a video server or content provider, a computer graphics system for generating computer graphics video data, a combination of such sources, or any other suitable video source.

The video data from the video source 102 may include one or more input pictures or frames. A picture or frame is a still image that is part of a video. The encoder engine 106 (or encoder) of the encoding device 104 encodes the video data to generate an encoded video bitstream. In some examples, an encoded video bitstream (or “bitstream”) is a series of one or more coded video sequences. A coded video sequence (CVS) includes a series of access units (AUs) starting with an AU that has a random access point picture in the base layer and with certain properties up to and not including a next AU that has a random access point picture in the base layer and with certain properties. For example, the certain properties of a random access point picture that starts a CVS may include a RASL flag (e.g., NoRaslOutputFlag) equal to 1. Otherwise, a random access point picture (with RASL flag equal to 0) does not start a CVS. An access unit (AU) includes one or more coded pictures and control information corresponding to the coded pictures that share the same output time. An HEVC bitstream, for example, may include one or more CVSs including data units called network abstraction layer (NAL) units. Two classes of NAL units exist in the HEVC standard, including video coding layer (VCL) NAL units and non-VCL NAL units. A VCL NAL unit includes one slice or slice segment (described below) of coded picture data, and a non-VCL NAL unit includes control information that relates to one or more coded pictures. An HEVC AU includes VCL NAL units containing coded picture data and non-VCL NAL units (if any) corresponding to the coded picture data.

NAL units may contain a sequence of bits forming a coded representation of the video data (e.g., an encoded video bitstream, a CVS of a bitstream, or the like), such as coded representations of pictures in a video. The encoder engine 106 generates coded representations of pictures by partitioning each picture into multiple slices. A slice is independent of other slices so that information in the slice is coded without dependency on data from other slices within the same picture. A slice includes one or more slice segments including an independent slice segment and, if present, one or more dependent slice segments that depend on previous slice segments. The slices are then partitioned into coding tree blocks (CTBs) of luma samples and chroma samples. A CTB of luma samples and one or more CTBs of chroma samples, along with syntax for the samples, are referred to as a coding tree unit (CTU). A CTU is the basic processing unit for HEVC encoding. A CTU can be split into multiple coding units (CUs) of varying sizes. A CU contains luma and chroma sample arrays that are referred to as coding blocks (CBs).

The luma and chroma CBs can be further split into prediction blocks (PBs). A PB is a block of samples of the luma or a chroma component that uses the same motion parameters for inter-prediction. The luma PB and one or more chroma PBs, together with associated syntax, form a prediction unit (PU). A set of motion parameters is signaled in the bitstream for each PU and is used for inter-prediction of the luma PB and the one or more chroma PBs. A CB can also be partitioned into one or more transform blocks (TBs). A TB represents a square block of samples of a color component on which the same two-dimensional transform is applied for coding a prediction residual signal. A transform unit (TU) represents the TBs of luma and chroma samples, and corresponding syntax elements.

A size of a CU corresponds to a size of the coding node and is square in shape. For example, a size of a CU may be 8×8 samples, 16×16 samples, 32×32 samples, 64×64 samples, or any other appropriate size up to the size of the corresponding CTU. The phrase “N×N” is used herein to refer to pixel dimensions of a video block in terms of vertical and horizontal dimensions (e.g., 8 pixels×8 pixels). The pixels in a block may be arranged in rows and columns. In some embodiments, blocks may not have the same number of pixels in a horizontal direction as in a vertical direction. Syntax data associated with a CU may describe, for example, partitioning of the CU into one or more PUs. Partitioning modes may differ between whether the CU is intra-prediction mode encoded or inter-prediction mode encoded. PUs may be partitioned to be non-square in shape. Syntax data associated with a CU may also describe, for example, partitioning of the CU into one or more TUs according to a CTU. A TU can be square or non-square in shape.

According to the HEVC standard, transformations may be performed using transform units (TUs). TUs may vary for different CUs. The TUs may be sized based on the size of PUs within a given CU. The TUs may be the same size or smaller than the PUs. In some examples, residual samples corresponding to a CU may be subdivided into smaller units using a quadtree structure known as residual quad tree (RQT). Leaf nodes of the RQT may correspond to TUs. Pixel difference values associated with the TUs may be transformed to produce transform coefficients. The transform coefficients may then be quantized by the encoder engine 106.

Once the pictures of the video data are partitioned into CUs, the encoder engine 106 predicts each PU using a prediction mode. The prediction is then subtracted from the original video data to get residuals (described below). For each CU, a prediction mode may be signaled inside the bitstream using syntax data. A prediction mode may include intra-prediction (or intra-picture prediction) or inter-prediction (or inter-picture prediction). Using intra-prediction, each PU is predicted from neighboring image data in the same picture using, for example, DC prediction to find an average value for the PU, planar prediction to fit a planar surface to the PU, direction prediction to extrapolate from neighboring data, or any other suitable types of prediction. Using inter-prediction, each PU is predicted using motion compensation prediction from image data in one or more reference pictures (before or after the current picture in output order). The decision whether to code a picture area using inter-picture or intra-picture prediction may be made, for example, at the CU level.

In some examples, inter-prediction using uni-prediction may be performed, in which case each prediction block can use one motion compensated prediction signal, and P prediction units are generated. In some examples, inter-prediction using bi-prediction may be performed, in which case each prediction block uses two motion compensated prediction signals, and B prediction units are generated.

A PU may include data related to the prediction process. For example, when the PU is encoded using intra-prediction, the PU may include data describing an intra-prediction mode for the PU. As another example, when the PU is encoded using inter-prediction, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

The encoder 104 may then perform transformation and quantization. For example, following prediction, the encoder engine 106 may calculate residual values corresponding to the PU. Residual values may comprise pixel difference values. Any residual data that may be remaining after prediction is performed is transformed using a block transform, which may be based on discrete cosine transform, discrete sine transform, an integer transform, a wavelet transform, or other suitable transform function. In some cases, one or more block transforms (e.g., sizes 32×32, 16×16, 8×8, 4×4, or the like) may be applied to residual data in each CU. In some embodiments, a TU may be used for the transform and quantization processes implemented by the encoder engine 106. A given CU having one or more PUs may also include one or more TUs. As described in further detail below, the residual values may be transformed into transform coefficients using the block transforms, and then may be quantized and scanned using TUs to produce serialized transform coefficients for entropy coding.

In some implementations following intra-prediction or inter-prediction coding using PUs of a CU, the encoder engine 106 may calculate residual data for the TUs of the CU. The PUs may comprise pixel data in the spatial domain (or pixel domain). The TUs may comprise coefficients in the transform domain following application of a block transform. As previously noted, the residual data may correspond to pixel difference values between pixels of the unencoded picture and prediction values corresponding to the PUs. Encoder engine 106 may form the TUs including the residual data for the CU, and may then transform the TUs to produce transform coefficients for the CU.

The encoder engine 106 may perform quantization of the transform coefficients. Quantization provides further compression by quantizing the transform coefficients to reduce the amount of data used to represent the coefficients. For example, quantization may reduce the bit depth associated with some or all of the coefficients. In one example, a coefficient with an n-bit value may be rounded down to an m-bit value during quantization, with n being greater than m.

Once quantization is performed, the coded bitstream includes quantized transform coefficients, prediction information (e.g., prediction modes, motion vectors, or the like), partitioning information, and any other suitable data, such as other syntax data. The different elements of the coded bitstream may then be entropy encoded by the encoder engine 106. In some examples, the encoder engine 106 may utilize a predefined scan order to scan the quantized transform coefficients to produce a serialized vector that can be entropy encoded. In some examples, encoder engine 106 may perform an adaptive scan. After scanning the quantized transform coefficients to form a one-dimensional vector, the encoder engine 106 may entropy encode the one-dimensional vector. For example, the encoder engine 106 may use context adaptive variable length coding, context adaptive binary arithmetic coding, syntax-based context-adaptive binary arithmetic coding, probability interval partitioning entropy coding, or another suitable entropy encoding technique.

As previously described, an HEVC bitstream includes a group of NAL units. A sequence of bits forming the coded video bitstream is present in VCL NAL units. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). The goal of the parameter sets is bit rate efficiency, error resiliency, and providing systems layer interfaces. Each slice references a single active PPS, SPS, and VPS to access information that the decoding device 112 may use for decoding the slice. An identifier (ID) may be coded for each parameter set, including a VPS ID, an SPS ID, and a PPS ID. An SPS includes an SPS ID and a VPS ID. A PPS includes a PPS ID and an SPS ID. Each slice header includes a PPS ID. Using the IDs, active parameter sets can be identified for a given slice.

A PPS includes information that applies to all slices in a given picture. Because of this, all slices in a picture refer to the same PPS. Slices in different pictures may also refer to the same PPS. An SPS includes information that applies to all pictures in a same coded video sequence (CVS) or bitstream. As previously described, a coded video sequence is a series of access units (AUs) that starts with a random access point picture (e.g., an instantaneous decode reference (IDR) picture or broken link access (BLA) picture, or other appropriate random access point picture) in the base layer and with certain properties (described above) up to and not including a next AU that has a random access point picture in the base layer and with certain properties (or the end of the bitstream). The information in an SPS may not change from picture to picture within a coded video sequence. Pictures in a coded video sequence may use the same SPS. The VPS includes information that applies to all layers within a coded video sequence or bitstream. The VPS includes a syntax structure with syntax elements that apply to entire coded video sequences. In some embodiments, the VPS, SPS, or PPS may be transmitted in-band with the encoded bitstream. In some embodiments, the VPS, SPS, or PPS may be transmitted out-of-band in a separate transmission than the NAL units containing coded video data.

The output 110 of the encoding device 104 may send the NAL units making up the encoded video data over the communications link 120 to the decoding device 112 of the receiving device. The input 114 of the decoding device 112 may receive the NAL units. The communications link 120 may include a signal transmitted using a wireless network, a wired network, or a combination of a wired and wireless network. A wireless network may include any wireless interface or combination of wireless interfaces and may include any suitable wireless network (e.g., the Internet or other wide area network, a packet-based network, WiFi™, radio frequency (RF), UWB, WiFi-Direct, cellular, Long-Term Evolution (LTE), WiMax™, or the like). A wired network may include any wired interface (e.g., fiber, ethernet, powerline ethernet, ethernet over coaxial cable, digital signal line (DSL), or the like). The wired and/or wireless networks may be implemented using various equipment, such as base stations, routers, access points, bridges, gateways, switches, or the like. The encoded video data may be modulated according to a communication standard, such as a wireless communication protocol, and transmitted to the receiving device.

In some examples, the encoding device 104 may store encoded video data in storage 108. The output 110 may retrieve the encoded video data from the encoder engine 106 or from the output 110. Storage 108 may include any of a variety of distributed or locally accessed data storage media. For example, the storage 108 may include a hard drive, a storage disc, flash memory, volatile or non-volatile memory, or any other suitable digital storage media for storing encoded video data.

The input 114 receives the encoded video data and may provide the video data to the decoder engine 116 or to storage 118 for later use by the decoder engine 116. The decoder engine 116 may decode the encoded video data by entropy decoding (e.g., using an entropy decoder) and extracting the elements of the coded video sequence making up the encoded video data. The decoder engine 116 may then rescale and perform an inverse transform on the encoded video data. Residues are then passed to a prediction stage of the decoder engine 116. The decoder engine 116 then predicts a block of pixels (e.g., a PU). In some examples, the prediction is added to the output of the inverse transform.

The decoding device 112 may output the decoded video to a video destination device 112, which may include a display or other output device for displaying the decoded video data to a consumer of the content. In some aspects, the video destination device 122 may be part of the receiving device that includes the decoding device 112. In some aspects, the video destination device 122 may be part of a separate device other than the receiving device.

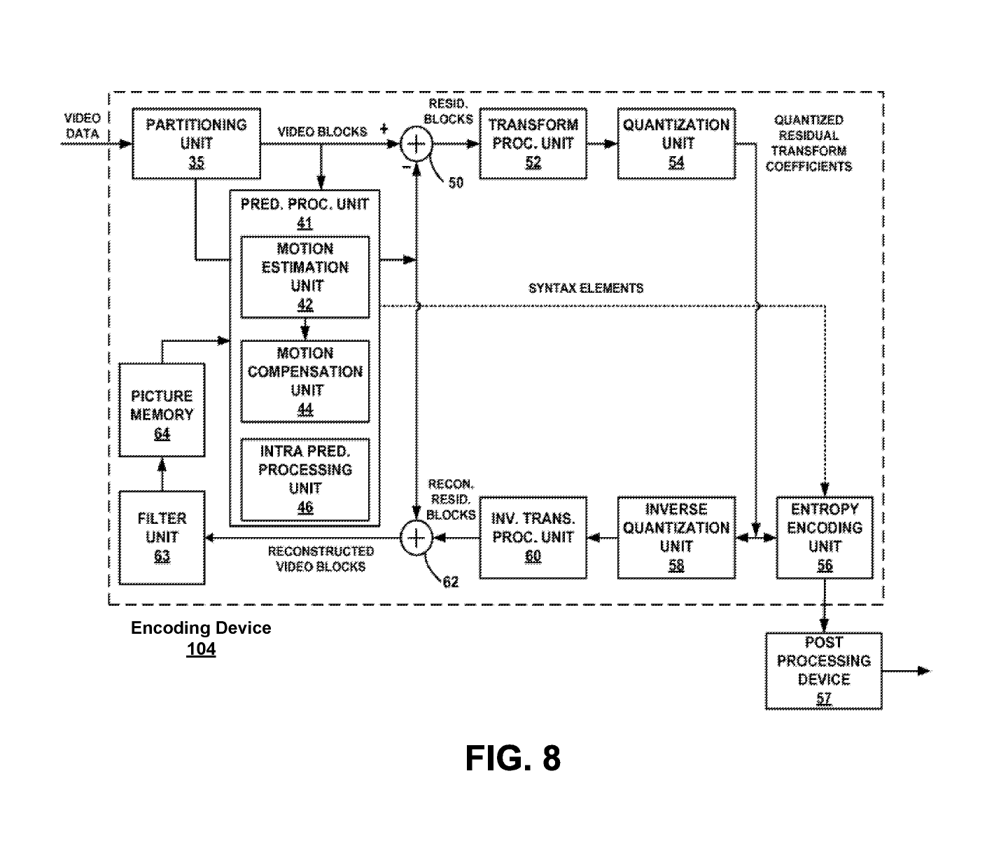

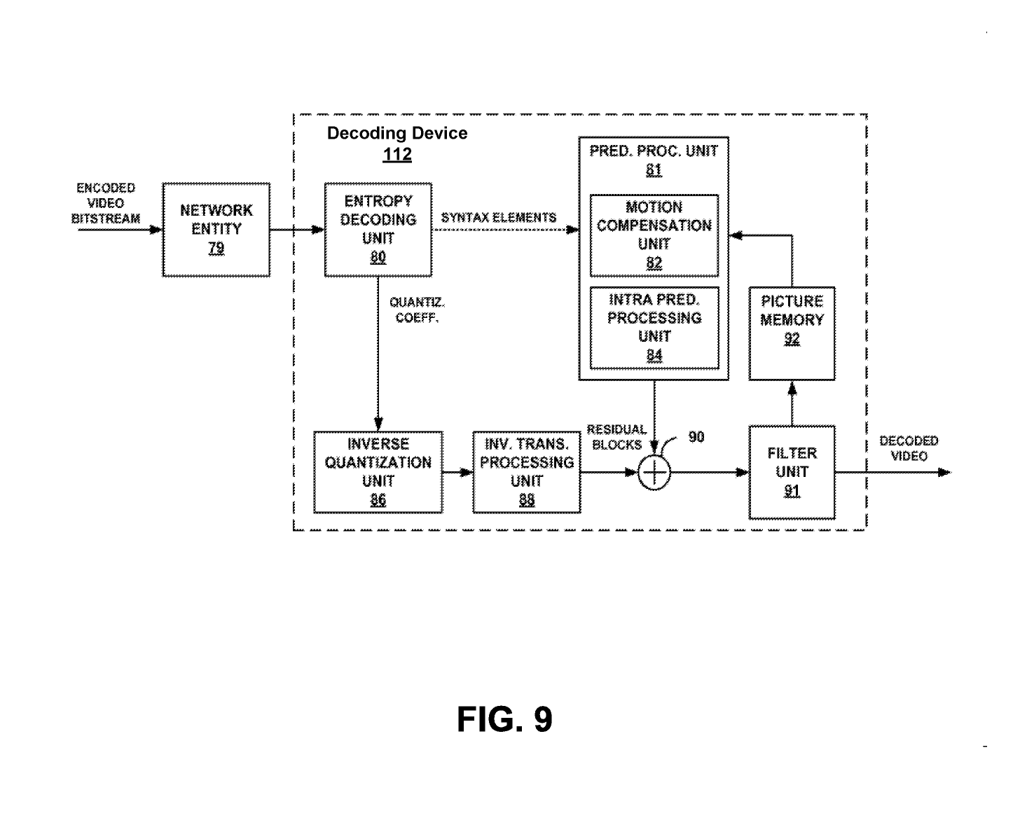

In some embodiments, the video encoding device 104 and/or the video decoding device 112 may be integrated with an audio encoding device and audio decoding device, respectively. The video encoding device 104 and/or the video decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The video encoding device 104 and the video decoding device 112 may be integrated as part of a combined encoder/decoder (codec) in a respective device. An example of specific details of the encoding device 104 is described below with reference to FIG. 8. An example of specific details of the decoding device 112 is described below with reference to FIG. 9.

Extensions to the HEVC standard include the Multiview Video Coding extension, referred to as MV-HEVC, and the Scalable Video Coding extension, referred to as SHVC. The MV-HEVC and SHVC extensions share the concept of layered coding, with different layers being included in the encoded video bitstream. Each layer in a coded video sequence is addressed by a unique layer identifier (ID). A layer ID may be present in a header of a NAL unit to identify a layer with which the NAL unit is associated. In MV-HEVC, different layers usually represent different views of the same scene in the video bitstream. In SHVC, different scalable layers are provided that represent the video bitstream in different spatial resolutions (or picture resolution) or in different reconstruction fidelities. The scalable layers may include a base layer (with layer ID=0) and one or more enhancement layers (with layer IDs=1, 2, . . . n). The base layer may conform to a profile of the first version of HEVC, and represents the lowest available layer in a bitstream. The enhancement layers have increased spatial resolution, temporal resolution or frame rate, and/or reconstruction fidelity (or quality) as compared to the base layer. The enhancement layers are hierarchically organized and may (or may not) depend on lower layers. In some examples, the different layers may be coded using a single standard codec (e.g., all layers are encoded using HEVC, SHVC, or other coding standard). In some examples, different layers may be coded using a multi-standard codec. For example, a base layer may be coded using AVC, while one or more enhancement layers may be coded using SHVC and/or MV-HEVC extensions to the HEVC standard.

Investigation for new coding tools for screen-content material such as text and graphics with motion has been performed, and technologies that improve the coding efficiency for screen content have been proposed. Because there is evidence that significant improvements in coding efficiency can be obtained by exploiting the characteristics of screen content with novel dedicated coding tools, a Call for Proposals (CfP) has been issued with the target of possibly developing future extensions of the High Efficiency Video Coding (HEVC) standard including specific tools for screen content coding (SCC). Companies and organizations are invited to submit proposals in response to this Call. The use cases and requirements of this CfP are described in MPEG document N14174.

As previously described, various prediction modes may be used in a video coding process, including intra-prediction and inter-prediction. One form of intra-prediction includes intra-block copy (IBC). For example, the SCC extension to HEVC has an intra-block copy mode. The intra-block copy mode uses prediction coming from the same picture as the current block, and the prediction is identified by a motion vector called a block vector (BV). For example, using redundancy in a picture, intra-block copy performs block matching to predict a block of samples (e.g., a CU, a PU, or other coding block) as a displacement from a reconstructed block of samples in a neighboring region of the picture. By removing the redundancy from repeating patterns of content, the intra-block copy prediction improves coding efficiency.

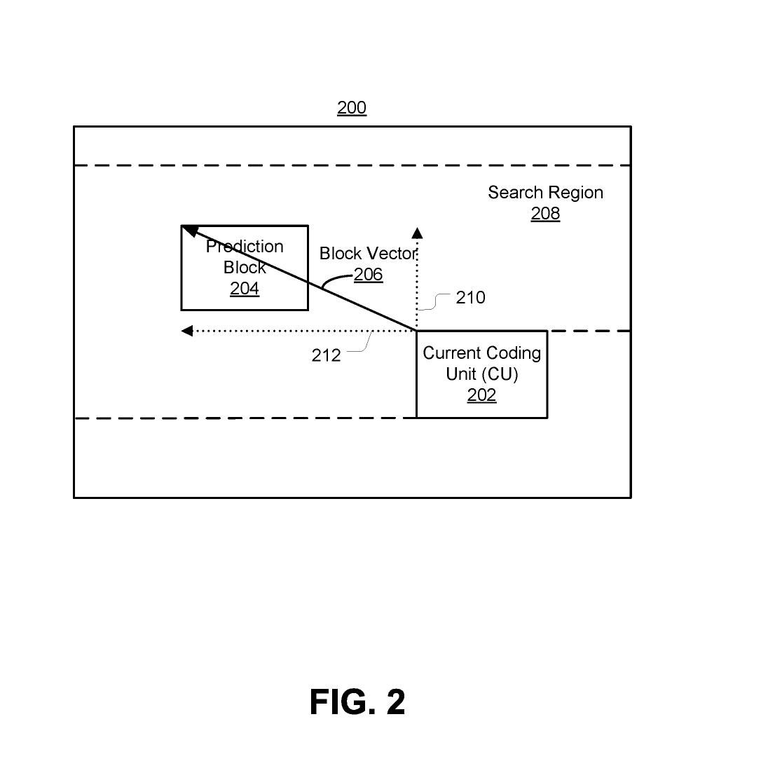

In some examples, intra-block copy enables spatial prediction from non-neighboring samples but within the current picture. FIG. 2 illustrates an example of a coded picture 200 in which intra-block copy is used to predict a current coding unit 202. In the example of FIG. 2, a video encoder has determined a prediction block 204 for predicting a current coding unit 202. The video encoder selected the prediction block 204 from previously reconstructed blocks of video data. The video encoder can reconstruct blocks of video data by inverse quantizing and inverse transforming the video data that is also included in the encoded video bitstream, and summing the resulting residual blocks with the predictive blocks used to predict the reconstructed blocks of video data.

In the example of FIG. 2, search region 208 within the coded picture 200, which may also be referred to as an “intended area” or “raster area,” includes a set of previously reconstructed video blocks. The video encoder may determine the prediction block 204 to predict current coding unit 202 from among the video blocks in the search region 208 based on an analysis of the relative efficiency and accuracy of predicting and the coding current coding unit 202 using the video blocks within search region 208.

The video encoder can determine a two-dimensional vector 206 (also called a block vector) representing the location or displacement of the prediction block 204 relative to the current coding unit 202. The two-dimensional motion vector 206 includes horizontal displacement component 212 and vertical displacement component 210, which respectively represent the horizontal and vertical displacement of prediction block 204 relative to current coding unit 202. The video encoder may include one or more syntax elements that identify or define the two-dimensional motion vector 206. For example, the syntax elements can that define the horizontal displacement component 212 and the vertical displacement component 210, in the encoded video bitstream. A video decoder may decode the one or more syntax elements to determine the two-dimensional motion vector 206, and use the determined motion vector to identify the prediction block 204 for current coding unit 202.

The current coding unit 202 can be predicted from the already decoded prediction block 204 (before in-loop filtering) of the coded picture 200 using the block vector 206. In-loop filtering may include both in-loop de-blocking filter and Sample Adaptive Offset (SAO). In the decoder, the predicted values are added to the residues without any interpolation. For example, the block vector 206 may be signaled as an integer value. After block vector prediction, the block vector difference is encoded using a motion vector difference coding method, such as that specified in the HEVC standard. Intra-block copy is enabled at both CU and PU level. For PU level intra-block copy, 2N×N and N×2N PU partition is supported for all the CU sizes. In addition, when the CU is the smallest CU, N×N PU partition is supported.

As noted above, in some versions of HEVC, chroma interpolation is allowed for intra-block copy, for certain sampling formats, such as non-4:4:4 formats. Intra-block copy may include chroma interpolation in cases, for example, when the motion vector is a fractional, rather than integer, value. In some cases, intra-block copy can also include luma interpolation.

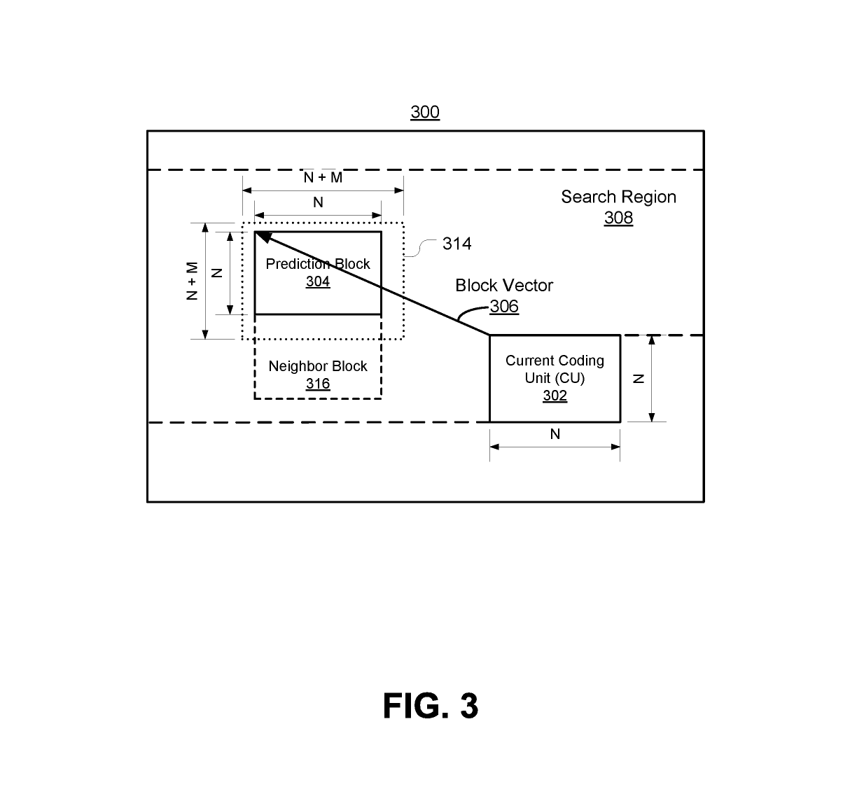

With chroma and/or luma interpolation, the pixels being used as reference pixels may be outside of the prediction block. FIG. 3 illustrates an example of a coded picture 300 in which intra-block copy is being used to predict a current coding unit 302. In this example, a video encoder has determined a prediction block 304 for predicting a current coding unit 302. The video encoder selected the prediction block 304 from a search region 308 that includes previously reconstructed blocks of video data within coded picture 300. The prediction block 304 can be identified by a motion vector, also referred to as a block vector 306. The current coding unit 302, having been predicted using intra-block copy, can also be referred to as an intra-block copy block.

In some cases, such as when chroma and/or luma interpolation is enabled, the current coding unit 302 may be predicted from pixels outside of the prediction block 304. For example, In one example, if the size of the current coding unit 302 is N×N, and M is the length of the interpolation filter, the area of size (N+M)×(N+M) with the location identified by the block vector can be used to predict the current coding unit 302. In the example of FIG. 3, the area 314 outside of the prediction block 304 that is due to the interpolation filter is illustrated by a dotted line.

Pixels in the area 314 outside of the prediction block 304 will fall inside other video blocks, such as the neighbor block 316 illustrated in this example. In some cases, it may be that the neighbor block 316 was predicted using inter-prediction, such that the prediction for the neighbor block 316 is based on samples from other pictures. In such cases, should the chroma and/or luma prediction of the current coding unit 302 use pixels in the area 314 outside the prediction block 304, the current coding unit 302 would also be predicted using inter-predicted samples.

As noted above, however, when constrained intra-prediction is enabled, all inter-predicted samples are not allowed. Constrained intra-prediction thus requires that the prediction block 304 has itself been predicted using only intra-predicted samples. Constrained intra-prediction further requires that all samples in the area 314 outside the prediction block 304 be intra-predicted, or otherwise not be used.

In some cases, in intra-block copy mode, interpolation filters are used only for chroma. In some cases, interpolation filters can be used for luma in the intra-block copy mode. In one example, M can be the maximum of the interpolation filter lengths for luma and chroma. In another example, M can be defined per color component.

In some cases, though reference sample taken from either the prediction block 304 or the area 314 outside the prediction block (due to interpolation being enabled) was intra-predicted, some reference sample in the past history of the reference sample may have been inter-predicted. For example, assume the reference sample taken from either the prediction block 304 or the area 314 outside the prediction block is reference sample A. Reference sample A may have been inter-predicted from a reference sample B elsewhere in the search region 308. Reference sample B, however, may have been inter-predicted from a reference sample C in another picture. Thus, because reference sample A has an inter-predicted sample in its prediction history, reference sample A does not satisfy the constrained intra-prediction requirement.

In various implementations, one technique for satisfying constrained intra-prediction when using intra-block copy is to constrain the samples used for intra-block copy. Specifically, in the example of FIG. 3, the prediction block 304 can only be selected if the prediction block 304 itself was predicted without using any inter-predicted samples. “Any” inter-predicted samples includes any inter-predicted samples in the prediction history of the prediction block 304. If the prediction block 304 was itself predicted using an inter-prediction mode, the prediction block 304 can be rejected, and another block in the search region 308 can be selected as the prediction block. Furthermore, if, due to chroma or luma interpolation, pixels in the neighbor block 316 are selected as reference samples, and those pixels were inter-predicted or have an inter-predicted sample in their prediction history, the pixels may be rejected and replaced with intra-predicted samples. For example, neighboring pixels may be selected, or samples may be generated using predefined values.

In the example of FIG. 3, the prediction block 304 is illustrated as including one block of video data. In various other examples, the prediction block 304 can include multiple blocks of video data. In these examples, the blocks within the prediction block 304 can be all intra-predicted blocks, can be all inter-predicted blocks, or can be a combination of intra-predicted blocks and inter-predicted blocks. In these examples, the samples used for intra-block copy prediction of the current coding unit 302 can include inter-predicted samples even when chroma-interpolation is not enabled.

In some cases, however, the current coding unit 302 may have better compression efficiency if the current coding unit 302 is predicted without the constrained intra-prediction constraint. In various implementations, the current coding unit 302 can thus be classified into one of two categories:

Type 1: intra-block copy blocks that were predicted using samples that satisfy the constrained-intra prediction constraint; and

Type 2: intra-block copy blocks that were predicted using at least one inter-coded sample.

In various implementations, the intra-block copy type for a block can be derived or determined by checking all the samples used for prediction of the block (including the samples required for interpolation). If all the samples satisfy the constrained intra-block copy constraint, then the intra-block copy block is determined to be of Type 1; otherwise the intra-block copy block is determined to be Type 2. In some implementation, a virtual flag may be assigned to each intra-block copy block. For example, the flag can be set to 1 to indicate that the block is a Type 1 intra-block copy block, and can be set to 0 to indicate that the block is a Type 2 intra-block copy block.

In various implementations, when a coding unit 302 is predicted, samples in the coding unit can be assigned Type 1 or Type 2, and the assigned type can be propagates when the coding unit is itself used for reference samples. For example, assume that a reference sample A is taken from the prediction block 304. Reference sample A may have been intra-predicted from a reference sample B, which may itself have been inter-predicted. In this example, reference B may be assigned Type 1 (assuming that intra-block copy mode was enabled for reference sample B). In this example, reference sample A may also be assigned Type 1. Thus when reference sample A is used to predict the current coding unit 302, the system can refer to the type of reference sample A to determine whether reference sample A meets the constrained intra-prediction requirement, and need not trace the history of reference sample A. As another example, assume that a reference sample C is taken from prediction block 304. Reference sample

C was intra-predicted from reference sample D, which was inter-predicted. In this example, reference sample D would be assigned Type 2 (assuming intra-block copy mode is enabled for reference sample D). Reference sample C would also be assigned Type 2, even though reference sample C was intra-predicted, because reference sample C is referring to an inter-predicted reference sample. Reference sample C further cannot be used as a reference when intra-block copy mode and constrained intra-prediction are enabled.

In various implementations, using these type designations, intra-block copy Type 1 blocks can be used when constrained intra-prediction is enabled. For example, such samples can be used as a reference for intra-prediction and intra-block copy Type 1 block prediction.

In some examples, the intra-block copy type assignment can be controlled by a video encoding device. For example, when constrained intra-prediction is enabled, the encoding device can decide that a particular block is not needed for the intra-prediction. The particular block can then use inter-samples for prediction, which may improve coding efficiency. Additionally, in some implementations, the particular block can be designated as a Type 2 intra-block copy block. Otherwise, in cases when the encoding device determines that a particular block is needed for intra-prediction, the encoder may search for a prediction area or prediction samples which satisfies the constrained intra-prediction constraint. In some implementations, such a block can also be assigned as a Type 1 intra-block copy block.

Similar classification into types or categories can be done on a pixel basis, rather than on a block basis. For example, each pixel can be classified into two types or categories based on whether it is determined that the pixel was predicted using intra-prediction (Type 1 pixels), thus satisfying the constrained intra-prediction constraint, or was predicted using inter-prediction (Type 2 pixels), and thus not available for intra-coding.

As discussed previously, the two types of prediction—intra-prediction and inter-prediction—use different information to predict the pixels in a current picture. Intra-prediction does not include prediction from any reference picture, using only sample prediction using reconstructed samples from the current picture. Inter-prediction uses reference pictures where picture identifiers, called reference indices, identify the reference picture and motion vectors are used to specify what part of which reference picture to use for prediction.

There are three slice types in HEVC: I-slices, P slices, and B-slices. Intra, or I-slices use only intra-prediction. Predictive, or P-slices, can use intra-prediction and inter-prediction using one reference picture per block, using one motion vector and one reference index. Using one reference picture per block, one motion vector and one reference index is referred to as uni-prediction. Bi-predictive, or B-slices, can use intra-prediction, uni-prediction, and also inter-prediction using two-motion vectors and two reference indices. Using two motion vectors and two reference indices is referred to as bi-prediction, and can result in two prediction blocks that can be combined to form a final prediction block. Using bi-prediction can be more compression efficient than using uni-prediction, but can also be computationally more complex.

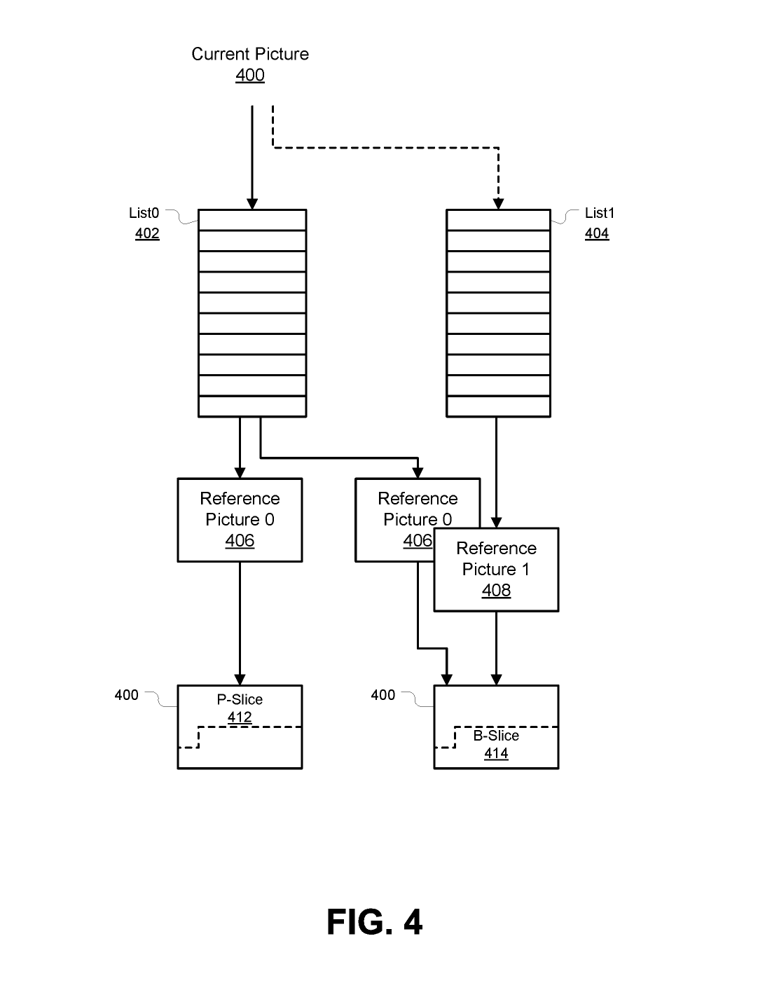

During decoding, a decoding device maintains two reference picture lists, list0 and list1. FIG. 4 illustrates an example of the relationship between reference picture lists, list0 402 and list1 404, and slices of different types. The reference picture lists 402, 404 can store identifiers for pictures that precede a current picture and/or pictures that follow the current picture, where the order of the pictures is given by a unique picture order count (POC). That is, each picture has a POC that indicates the picture's order in a coded video sequence. Pictures referenced in list0 402 can be used for both P-slices 412 and B-slices 414, while pictures referenced in list1 404 are only used for B-slices 414.

In some versions of HEVC, the current picture 400 (or, more specifically, an identifier, such as a POC, for the current picture 400) is added only to list0 402. As such, in these versions of HEVC, a block in the current picture can be identified as an intra-block copy block by comparing the POC for the current picture 400 to the POC of the reference picture. When the POC of the current picture 400 is the same as the POC of the reference picture, the decoding device can determine that the block is an intra-block copy block. This is because the block is referencing a prediction block using a motion vector, which is normally used in inter-prediction, but because the reference picture is the same as the current picture, the motion vector is being used pursuant to intra-block copy.

In other versions of HEVC, the current picture 400 can be added to both list0 and list1. For example, the current picture 400 may be marked as “used for long-term reference” (as opposed to short-term reference), and may be added to both list0 and list1 when the current picture 400 indicates that the current picture 400 can be used as a reference picture. In these versions of HEVC, for B-slices 414, either a reference picture 0 406 from list0 402 can be the current picture 400, or a reference picture 1 408 from list 1 can be the current picture 400, or both reference picture 0 406 and reference picture 1 408 can be the same as the current picture 400.

In various implementations, a new intra-block copy check can be used for bi-predicted blocks when constrained intra-prediction is enabled. Specifically, the identity of the reference picture 0 406 and the reference picture 1 408 can still be used to identify a block as an intra-block copy block. When both reference picture 0 406 and reference picture 1 408 have POCs that are the same as the POC for the current picture 400, a decoder can identify a block in the current picture as an intra-block copy block. When either reference picture 0 406 or reference picture 1 408 do not have a POC that is the same as the POC for the current picture 400, the decoder can determine that the block is an inter-block. The block, thus identified as an inter-block, will not be used when constrained intra-prediction is enabled.

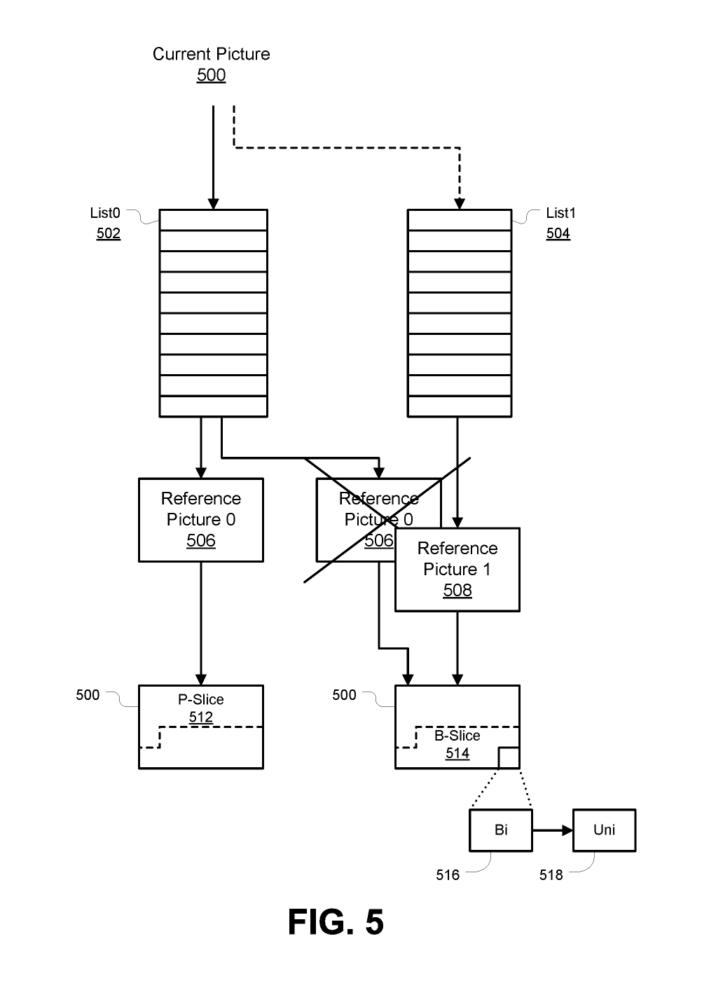

In various implementations, for bi-predicted blocks, when one reference picture is the same as the current picture and the other reference picture is not, alternate techniques can be used to ensure that the constrained intra-prediction constraint is still satisfied. FIG. 5 illustrates an example of the relationship between picture lists, list0 502 and list1 504, and slices of different types. The reference picture lists 502, 504 can store identifiers for pictures that precede a current picture and/or pictures that follow the current picture. In some implementations, the identifiers stored in the reference lists 502, 504 are the POCs for the reference frames. Pictures referenced in list0 502 can be used for both P-slices 512 and B-slices 514, while pictures referenced in list1 504 are only used for B-slices 514.

As discussed above, in some versions of HEVC, an identifier (e.g., the POC) of the current picture 500 can be added to both list0 502 and list1 504. Thus, a reference picture 0 506 from list0 502 and/or a reference picture 1 508 from list1 504 can be the same as the current picture 500. For example, a decoder device can compare the POC of reference picture 1 508 against the POC for the current picture 500, and if the POCs are the same, reference picture 1 508 is the same as the current picture 500. As a further example, in the same manner, the decoder device can determine that reference picture 0 506 is different from the current picture 500.

As noted above, a bi-predicted block 516 in a B-slice 514 may use as a reference block that combines information from both reference picture 0 506 and reference picture 1 508. When one of the reference pictures is not the current picture 500, the result is that the bi-predicted block 516 is inter-predicted. The bi-predicted block 516 thus violates the constrained intra-prediction constraint.

In various implementations, a conversion technique can be applied so that constrained intra-prediction can be satisfied. Generally, a bi-predicted block 516 can be converted to a un-predicted block by discarding prediction samples that do not satisfy the constrained intra-prediction constraint. Specifically, in various implementations, the bi-predicted block 516 can be converted to a uni-predicted block 518 by discarding the reference picture (reference picture 0 506 in the above example) that is not from the current picture. In other words, for a bi-predicted block 516, if one of the reference pictures being used for prediction satisfies the constrained intra-prediction rule and the other reference picture does not satisfy the constrained intra-prediction rule (because it is not the current picture), the bi-predicted block 516 is converted from bi-predicted to uni-predicted by discarding the reference picture that does not satisfy constrained intra-prediction.

In some implementations, an encoding device can apply an alignment technique for aligning a palette block with a transform size. In some cases, the alignment technique can be applied independently. Palette-based coding uses one or more palettes when coding video data. In palette-based coding, a video coder (e.g., a video encoding device or video decoding device) forms a “palette” of colors representing the video data of a given block. The palette may include the most dominant (e.g., frequently used) colors in the given block. The colors that are infrequently or rarely represented in the video data of the given block are not included in the palette. The colors that are not included in the palette are referred to as escape colors.

When an index map corresponding to the given block is coded during palette mode coding, each of the colors included in the palette is assigned an index value. For example, if the colors black and white are included in the palette, the color white may have an index value of 1 and the color black may have an index value of 2. In addition, each of the colors not included in the palette are assigned, for example, a single or common index value. For example, if the colors blue, green, and red are not included in the palette, these colors will all have an index value of 3. The index value for the colors not included in the palette may be referred to as an escape color index value.

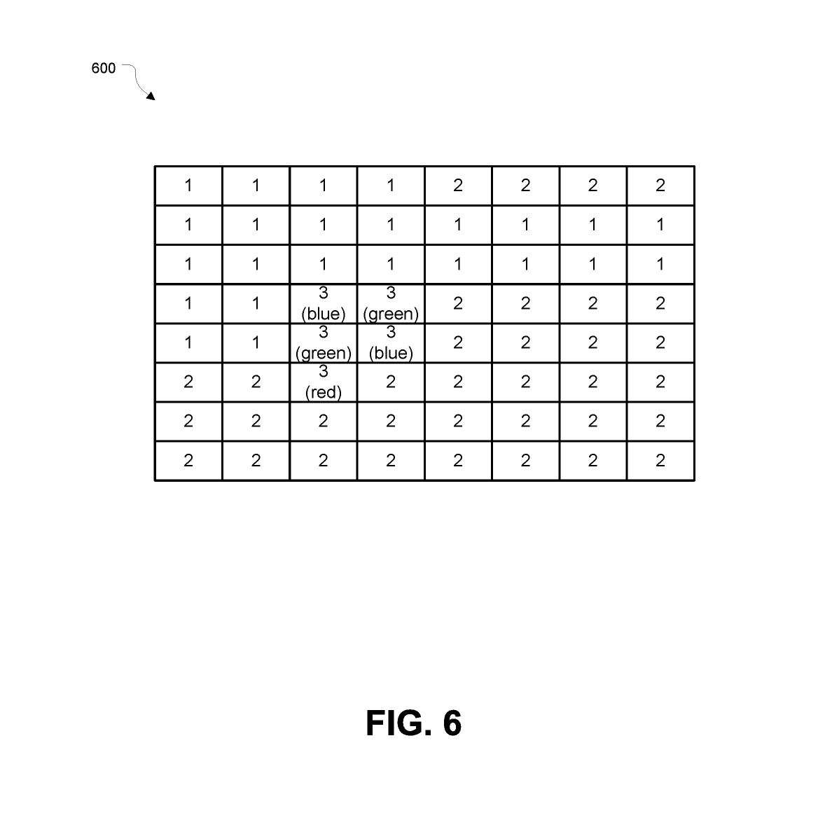

FIG. 6 illustrates an example of an index map 600 of colors, corresponding to particular video block. The index map 600 may have been coded during palette mode coding. In this example, the index map is 8×8. In this example, index values of 1 and 2 represent colors that occur in the palette, while 3 is used to indicate escape colors.

In some examples, a palette may include a table of pixel values (e.g., the index map 600) representing the video data of a particular area of a picture, such as a block of pixels within the picture. A video coder may code index values indicative of one or more of the pixel values of a given block. The index values indicate entries in the palette that are used to represent the pixel values of the given block. In some examples, a palette may include certain pixel values of the given block. For example, the pixel values included in a palette may include the one or more pixel values that occur most frequently within the block. A video encoder can encode a block of video data by determining a palette for the block, and locating an entry in the palette to represent one or more pixel values of the block. The video encoder may encode the block with index values that indicate entries in the palette used to represent the pixel values of the block. In some examples, the video encoder may signal the index values in an encoded video bitstream. A video decoder may obtain a palette for a block and index values for the pixels of the block. For example, the video decoder may obtain the palette and index values from an encoded video bitstream. The video decoder may relate the index values of the pixels to entries of the palette to reconstruct the pixel values of the block.

In some cases, the maximum possible palette coded block can have a 32×32 size, which is aligned with a maximum possible transform size. One of the benefits of such restriction is that there is no need to have an extra storage to keep the scanning pattern of 64×64, which is not needed for transform. However, in HEVC it is possible to configure minimum and maximum transform sizes. In particular, a minimum transform size can be bigger than 8×8, and a maximum transform size can be smaller than 32×32.

In various implementations, an alignment technique is described herein for restricting the palette mode to follow the transform size restriction. For example, a minimum allowable size of the palette coded block may be set equal to the minimum size of the transform block. In another example, a minimum allowable size of the palette coded block may be set equal to the maximum of minimum size of the transform block and 8. Similarly, the maximum allowable size of the palette coded block may be set equal to the maximum size of the transform block. In some cases, both of these restrictions may be applied simultaneously. An advantage of such alignment of a palette block with a transform size can be in memory allocation. For example, it can be known in advance that a palette will not exceed the transform size restriction, and there would be no need to allocate the memory for bigger blocks, for example to keep the scanning pattern.

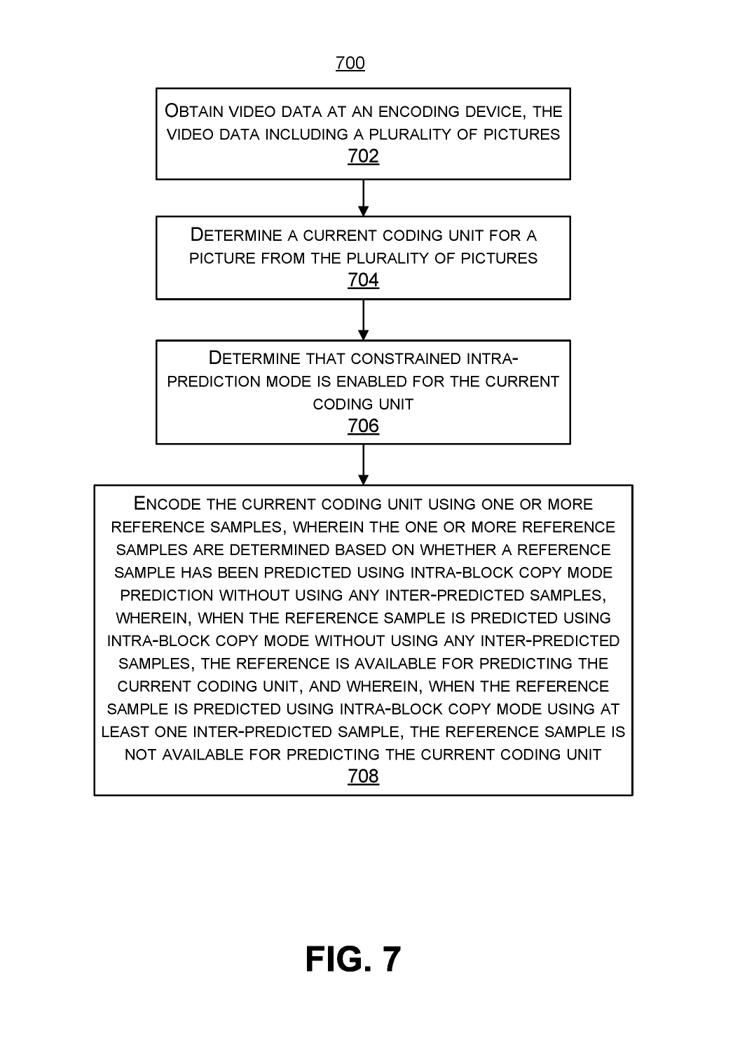

FIG. 7 illustrates an example of a process 700 for using intra-block copy blocks with constrained intra-prediction is enabled, according to the techniques described herein. At 702, the process 700 includes obtaining video data at an encoding device, the video data including a plurality of pictures. The video data may be obtained for a video source device, such as a camera, that is part of the same system as the encoding device. Alternatively or additionally, the video data may be obtained from a local storage device. Alternatively or additionally, the video data may be obtained over a network.

At 704, the process 700 includes determining a current coding unit for a picture form the plurality of pictures. A coding unit can be a sub-part of the picture that is individually encoded. In various implementations the coding unit can be predicted using reference samples from previously encoded parts of the picture.

At 706, the process 700 includes determining that constrained intra-prediction mode is enabled for the current coding unit. Constrained intra-prediction mode can be enabled for a group of pictures, for one picture, for one slice, or for some other grouping of video data. The coding unit can be included in the grouping of video data for which constrained intra-prediction mode is enabled.

At 708, the process 700 includes encoding the current coding unit using one or more reference samples. The one or more reference samples can be determined based on whether a reference sample has been predicted using intra-block copy mode without using any inter-predicted samples. Without using any inter-predicted samples includes any samples in the prediction history of a sample. When the reference sample has been predicted using intra-block copy mode without using any inter-predicted samples, the reference sample is available for predicting the current coding unit. When the reference sample has been predicted using intra-block copy mode using at least one inter-predicted sample, the reference sample is not available for predicting the current coding unit. The at least one inter-predicted sample can be in the prediction history of the reference sample, and need not be the reference sample itself.

Process 700 is illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The coding techniques discussed herein may be implemented in an example video encoding and decoding system (e.g., system 100 of FIG. 1). In some examples, a system includes a source device that provides encoded video data to be decoded at a later time by a destination device. In particular, the source device can provide the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above is merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

The input interface of the destination device receives information from the computer-readable medium. The information of the computer-readable medium may include syntax information defined by the video encoder, which is also used by the video decoder, that includes syntax elements that describe characteristics and/or processing of blocks and other coded units, e.g., group of pictures (GOP). A display device displays the decoded video data to a user, and may comprise any of a variety of display devices such as a cathode ray tube (CRT), a liquid crystal display (LCD), a plasma display, an organic light emitting diode (OLED) display, or another type of display device. Various embodiments have been described.

Specific details of the encoding device 104 and the decoding device 112 are shown in FIG. 8 and FIG. 9, respectively. FIG. 8 is a block diagram illustrating an example encoding device 104 that may implement one or more of the techniques described in this disclosure. The encoding device 104 may, for example, generate the syntax structures described herein (e.g., the syntax structures of a VPS, SPS, PPS, or other syntax elements). The encoding device 104 may perform intra-prediction and inter-prediction coding of video blocks within video slices. As previously described, intra-coding relies, at least in part, on spatial prediction to reduce or remove spatial redundancy within a given video frame or picture. For intra-coding, the encoding device 104 an form a spatial prediction block based on one or more previously encoded blocks within the same coding unit as the block being coded. Intra-mode (I mode) may refer to any of several spatial based compression modes. Inter-coding relies, at least in part, on temporal prediction to reduce or remove temporal redundancy within adjacent or surrounding frames of a video sequence. For inter-coding, the encoding device 104 can perform motion estimation to track the movement of closely matching video blocks between two or more adjacent frames. Inter-modes, such as uni-directional prediction (P mode) or bi-prediction (B mode), may refer to any of several temporal-based compression modes.

The example encoding device 104 includes a partitioning unit 35, prediction processing unit 41, filter unit 63, picture memory 64, first summer 50, transform processing unit 52, quantization unit 54, and entropy encoding unit 56. The prediction processing unit 41 includes a motion estimation unit 42, motion compensation unit 44, and intra-prediction processing unit 46. For video block reconstruction, the encoding device 104 also includes an inverse quantization unit 58, inverse transform processing unit 60, and second summer 62. The filter unit 63 is intended to represent one or more loop filters such as a de-blocking filter, an adaptive loop filter (ALF), and/or a sample adaptive offset (SAO) filter. Although the filter unit 63 is shown in FIG. 8 as being an in-loop filter, in other configurations, the filter unit 63 may be implemented as a post-loop filter. A post processing device 57 may perform additional processing on encoded video data generated by the encoding device 104. The techniques of this disclosure may in some instances be implemented by the encoding device 104. In other instances, however, one or more of the techniques of this disclosure may be implemented by post processing device 57.

As shown in FIG. 8, the encoding device 104 receives video data, and the partitioning unit 35 partitions the data into video blocks. The partitioning may also include partitioning into slices, slice segments, tiles, or other larger units, as wells as video block partitioning, e.g., according to a quadtree structure of LCUs and CUs. The example encoding device 104 generally illustrates the components that encode video blocks within a video slice to be encoded. The slice may be divided into multiple video blocks (and possibly into sets of video blocks referred to as tiles).

The encoding device 104 can perform intra- or inter-coding for each of the video blocks on a block-by-block basis based on the block type of the block. The prediction processing unit 41 may assign a block type to each of the video blocks, where the block type may indicate a partition size of the block as well as whether the block is to be predicted using inter-prediction or intra-prediction. The prediction processing unit 41 may further select one of a plurality of possible coding modes, such as one of a plurality of intra-prediction coding modes or one of a plurality of inter-prediction coding modes, for the current video block based on error results (e.g., coding rate and the level of distortion, or the like). The prediction processing unit 41 may provide the resulting intra- or inter-coded block to the first summer 50 to generate residual block data and to the second summer 62 to reconstruct the encoded block for use as a reference picture.

The prediction processing unit 41 can produce a prediction block. The prediction block is a block from which the current video block can be predicted. In the case of inter-prediction (e.g., when a video block has been assigned an inter-block type), the prediction processing unit 41 may perform temporal prediction for inter-coding of the current video block. The prediction processing 41 may, for example, compare the current video block to blocks in one or more adjacent video frames to identify a block in the adjacent frame that most closely matches the current video block. In this example, the prediction block may be chosen based on having the smallest Mean-Squared Error (MSE), Sum of Square Difference (SSD), or Sum of Absolute Difference (SAD) value, or base on some other metric.

In the case of intra-prediction (e.g., when a video block has been assigned an intra-block type), the prediction processing unit 41 can produce a prediction block based on one or more previously encoded neighboring blocks within a common coding unit. The prediction processing unit 41 can, for example, generate the prediction block by extrapolating or interpolating from previously-encoded neighboring video blocks in the current frame. Whether extrapolation or interpolation, and the direction from which samples are taken for extrapolation or interpolation, occurs depends on the particular intra-prediction mode. For example, intra-prediction modes include unidirectional prediction modes such as vertical, horizontal, diagonal down/left, vertical right, and others, and bi-directional prediction modes that combine unidirectional prediction modes.

In various implementations, the prediction processing unit 41 can include a motion estimation unit 42, a motion compensation units 44, and an intra-prediction processing unit 46. The motion estimation unit 42 and the motion compensation unit 44 within the prediction processing unit 41 perform inter-prediction coding of the current video block relative to one or more prediction blocks in one or more reference pictures to provide temporal compression. The intra-prediction processing unit 46 within the prediction processing unit 41 may perform intra-prediction coding of the current video block relative to one or more neighboring blocks in the same frame or slice as the current block to be coded to provide spatial compression.

The motion estimation unit 42 may be configured to determine the inter-prediction mode for a video slice according to a predetermined pattern for a video sequence. The predetermined pattern may designate video slices in the sequence as P slices, B slices, or GPB slices. The motion estimation unit 42 and motion compensation unit 44 may be highly integrated, but are illustrated separately for conceptual purposes. Motion estimation, performed by the motion estimation unit 42, is the process of generating motion vectors, which estimate motion for video blocks. A motion vector, for example, may indicate the displacement of a prediction unit (PU) of a video block within a current video frame or picture relative to a prediction block within a reference picture.

A prediction block is a block that is found to closely match the PU of the video block to be coded in terms of pixel difference, which may be determined by sum of absolute difference (SAD), sum of square difference (SSD), or other difference metrics. In some examples, the encoding device 104 may calculate values for sub-integer pixel positions of reference pictures stored in the picture memory 64. For example, the encoding device 104 may interpolate values of one-quarter pixel positions, one-eighth pixel positions, or other fractional pixel positions of the reference picture. Therefore, the motion estimation unit 42 may perform a motion search relative to the full pixel positions and fractional pixel positions and output a motion vector with fractional pixel precision.

The motion estimation unit 42 calculates a motion vector for a PU of a video block in an inter-coded slice by comparing the position of the PU to the position of a prediction block of a reference picture. The reference picture may be selected from a first reference picture list (List 0) or a second reference picture list (List 1), each of which identify one or more reference pictures stored in the picture memory 64. The motion estimation unit 42 sends the calculated motion vector to the entropy encoding unit 56 and the motion compensation unit 44.

Motion compensation, performed by the motion compensation unit 44, may involve fetching or generating the prediction block based on the motion vector determined by motion estimation, possibly performing interpolations to sub-pixel precision. Upon receiving the motion vector for the PU of the current video block, the motion compensation unit 44 may locate the prediction block to which the motion vector points in a reference picture list. The encoding device 104 forms a residual video block by subtracting pixel values of the prediction block from the pixel values of the current video block being coded, forming pixel difference values. The pixel difference values form residual data for the block, and may include both luma and chroma difference components. The first summer 50 represents the component or components that perform this subtraction operation. The motion compensation unit 44 may also generate syntax elements associated with the video blocks and the video slice for use by the decoding device 112 in decoding the video blocks of the video slice.

The intra-prediction processing unit 46 may intra-predict a current block, as an alternative to the inter-prediction performed by the motion estimation unit 42 and the motion compensation unit 44, as described above. In particular, the intra-prediction processing unit 46 may determine an intra-prediction mode to use to encode a current block. In some examples, the intra-prediction processing unit 46 may encode a current block using various intra-prediction modes, e.g., during separate encoding passes, and the intra-prediction processing unit 46 (or the mode selection unit 40, in some examples) may select an appropriate intra-prediction mode to use from the tested modes. For example, the intra-prediction processing unit 46 may calculate rate-distortion values using a rate-distortion analysis for the various tested intra-prediction modes, and may select the intra-prediction mode having the best rate-distortion characteristics among the tested modes. Rate-distortion analysis generally determines an amount of distortion (or error) between an encoded block and an original, un-encoded block that was encoded to produce the encoded block, as well as a bit rate (that is, a number of bits) used to produce the encoded block. The intra-prediction processing unit 46 may calculate ratios from the distortions and rates for the various encoded blocks to determine which intra-prediction mode exhibits the best rate-distortion value for the block.

In any case, after selecting an intra-prediction mode for a block, the intra-prediction processing unit 46 may provide information indicative of the selected intra-prediction mode for the block to the entropy encoding unit 56. The entropy encoding unit 56 may encode the information indicating the selected intra-prediction mode. The encoding device 104 may include in the transmitted bitstream configuration data definitions of encoding contexts for various blocks as well as indications of a most probable intra-prediction mode, an intra-prediction mode index table, and a modified intra-prediction mode index table to use for each of the contexts. The bitstream configuration data may include a plurality of intra-prediction mode index tables and a plurality of modified intra-prediction mode index tables (also referred to as codeword mapping tables).

After the prediction processing unit 41 generates the prediction block for the current video block via either inter-prediction or intra-prediction, the encoding device 104 forms a residual video block by subtracting the prediction block from the current video block. The residual data block includes a set of pixel difference values that quantify differences between pixel values of the current video data block and pixel values of the prediction block. The residual video data in the residual block may be included in one or more TUs and applied to the transform processing unit 52.

The transform processing unit 52 transforms the residual video data into residual transform coefficients using a transform, such as a discrete cosine transform (DCT), an integer transform, a directional transform, a wavelet transform, or a conceptually similar transform, or a combination of transforms. The transform processing unit 52 may convert the residual video data from a pixel domain to a transform domain, such as a frequency domain. The transform processing unit 52 may selectively apply transforms to the residual block based on the prediction mode selected by the prediction processing unit 41.

The transform processing unit 52 may send the resulting transform coefficients to the quantization unit 54. The quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, the entropy encoding unit 56 may perform the scan.

Following quantization, the entropy encoding unit 56 entropy encodes the quantized transform coefficients. For example, the entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding technique. Following the entropy encoding by the entropy encoding unit 56, the encoded bitstream may be transmitted to the decoding device 112, or archived for later transmission or retrieval by the decoding device 112. The entropy encoding unit 56 may also entropy encode the motion vectors and the other syntax elements for the current video slice being coded.

The inverse quantization unit 58 and the inverse transform processing unit 60 apply inverse quantization and inverse transformation, respectively, to reconstruct the residual block in the pixel domain for later use as a reference block of a reference picture. The motion compensation unit 44 may calculate a reference block by adding the residual block to a prediction block of one of the reference pictures within a reference picture list. The motion compensation unit 44 may also apply one or more interpolation filters to the reconstructed residual block to calculate sub-integer pixel values for use in motion estimation. The second summer 62 adds the reconstructed residual block to the motion compensated prediction block produced by the motion compensation unit 44 to produce a reference block for storage in the picture memory 64. The reference block may be used by the motion estimation unit 42 and the motion compensation unit 44 as a reference block to inter-predict a block in a subsequent video frame or picture.

In this manner, the encoding device 104 of FIG. 8 represents an example of a video encoder configured to generate syntax for a encoded video bitstream. The encoding device 104 may, for example, generate VPS, SPS, and PPS parameter sets as described above. The encoding device 104 may perform any of the techniques described herein, including the processes described above with respect to FIG. 7. The techniques of this disclosure have generally been described with respect to the encoding device 104, but as mentioned above, some of the techniques of this disclosure may also be implemented by the post processing device 57.

FIG. 9 is a block diagram illustrating an example decoding device 112. The decoding device 112 includes an entropy decoding unit 80, prediction processing unit 81, inverse quantization unit 86, inverse transform processing unit 88, summer 90, filter unit 91, and picture memory 92. The prediction processing unit 81 includes a motion compensation unit 82 and an intra-prediction processing unit 84. The decoding device 112 may, in some examples, perform a decoding pass generally reciprocal to the encoding pass described with respect to the encoding device 104 from FIG. 8.

During the decoding process, the decoding device 112 of FIG. 9 receives an encoded video bitstream that represents video blocks of an encoded video slice and associated syntax elements sent by the encoding device 104. In some embodiments, the decoding device 112 may receive the encoded video bitstream from the encoding device 104. In some embodiments, the decoding device 112 may receive the encoded video bitstream from a network entity 79, such as a server, a media-aware network element (MANE), a video editor/splicer, or other such device configured to implement one or more of the techniques described above. The network entity 79 may or may not include the encoding device 104. Some of the techniques described in this disclosure may be implemented by the network entity 79 prior to the network entity 79 transmitting the encoded video bitstream to the decoding device 112. In some video decoding systems, the network entity 79 and the decoding device 112 may be parts of separate devices, while in other instances, the functionality described with respect to the network entity 79 may be performed by the same device that comprises the decoding device 112.

The entropy decoding unit 80 of the decoding device 112 entropy decodes the bitstream to generate quantized coefficients, motion vectors, and other syntax elements. The entropy decoding unit 80 forwards the motion vectors and other syntax elements to the prediction processing unit 81. The decoding device 112 may receive the syntax elements at the video slice level and/or the video block level. The entropy decoding unit 80 may process and parse both fixed-length syntax elements and variable-length syntax elements in or more parameter sets, such as a VPS, SPS, and PPS.

When the video slice is coded as an intra-coded (I) slice, the intra-prediction processing unit 84 of the prediction processing unit 81 may generate prediction data for a video block of the current video slice based on a signaled intra-prediction mode and data from previously decoded blocks of the current frame or picture. When the video frame is coded as an inter-coded (i.e., B, P or GPB) slice, the motion compensation unit 82 of the prediction processing unit 81 produces prediction blocks for a video block of the current video slice based on the motion vectors and other syntax elements received from the entropy decoding unit 80. The prediction blocks may be produced from one of the reference pictures within a reference picture list. The decoding device 112 may construct the reference frame lists, List 0 and List 1, using default construction techniques based on reference pictures stored in the picture memory 92.

The motion compensation unit 82 determines prediction information for a video block of the current video slice by parsing the motion vectors and other syntax elements, and uses the prediction information to produce the prediction blocks for the current video block being decoded. For example, the motion compensation unit 82 may use one or more syntax elements in a parameter set to determine a prediction mode (e.g., intra- or inter-prediction) used to code the video blocks of the video slice, an inter-prediction slice type (e.g., B slice, P slice, or GPB slice), construction information for one or more reference picture lists for the slice, motion vectors for each inter-encoded video block of the slice, inter-prediction status for each inter-coded video block of the slice, and other information to decode the video blocks in the current video slice.

The motion compensation unit 82 may also perform interpolation based on interpolation filters. The motion compensation unit 82 may use interpolation filters as used by the encoding device 104 during encoding of the video blocks to calculate interpolated values for sub-integer pixels of reference blocks. In this case, the motion compensation unit 82 may determine the interpolation filters used by the encoding device 104 from the received syntax elements, and may use the interpolation filters to produce prediction blocks.

The inverse quantization unit 86 inverse quantizes, or de-quantizes, the quantized transform coefficients provided in the bitstream and decoded by the entropy decoding unit 80.

The inverse quantization process may include use of a quantization parameter calculated by the encoding device 104 for each video block in the video slice to determine a degree of quantization and, likewise, a degree of inverse quantization that should be applied. The inverse transform processing unit 88 applies an inverse transform (e.g., an inverse DCT or other suitable inverse transform), an inverse integer transform, or a conceptually similar inverse transform process, to the transform coefficients in order to produce residual blocks in the pixel domain.

After the motion compensation unit 82 generates the prediction block for the current video block based on the motion vectors and other syntax elements, the decoding device 112 forms a decoded video block by summing the residual blocks from the inverse transform processing unit 88 with the corresponding prediction blocks generated by the motion compensation unit 82. The summer 90 represents the component or components that perform this summation operation. If desired, loop filters (either in the coding loop or after the coding loop) may also be used to smooth pixel transitions, or to otherwise improve the video quality. The filter unit 91 is intended to represent one or more loop filters such as a de-blocking filter, an adaptive loop filter (ALF), and a sample adaptive offset (SAO) filter. Although the filter unit 91 is shown in FIG. 9 as being an in-loop filter, in other configurations, the filter unit 91 may be implemented as a post loop filter. The decoded video blocks in a given frame or picture are then stored in the picture memory 92, which stores reference pictures used for subsequent motion compensation. The picture memory 92 also stores decoded video for later presentation on a display device, such as video destination device 122 shown in FIG. 1.

In the foregoing description, aspects of the application are described with reference to specific embodiments thereof, but those skilled in the art will recognize that the embodiments are not limited to these descriptions. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments described herein.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method for encoding video data, comprising:
obtaining video data at an encoding device, the video data including a plurality of pictures;
determining a current coding unit for a picture from the plurality of pictures;
determining that constrained intra-prediction mode is enabled for the current coding unit;
encoding the current coding unit using one or more reference samples, wherein the one or more reference samples are determined based on whether a reference sample has been predicted using intra-block copy mode prediction without using any inter-predicted samples, wherein, when the reference sample is predicted using intra-block copy mode without using any inter-predicted samples, the reference sample is available for predicting the current coding unit, and wherein, when the reference sample is predicted using intra-block copy mode using at least one inter-predicted sample, the reference sample is not available for predicting the coding unit.

2. The method of claim 1, further comprising:
assigning a first type to the reference sample when the reference sample was predicted using intra-block copy mode prediction without using any inter-predicted samples; and
assigning a second type to the reference sample when the reference sample was predicted using intra-block copy mode prediction using at least one inter-predicted sample.

3. The method of claim 1, further comprising:
using the current coding unit as a prediction block to predict another coding unit based, wherein the current coding unit is used based on the reference sample having been predicted using intra-block copy mode prediction without using any inter-predicted samples.

4. The method of claim 1, wherein the current coding unit is encoded using the reference sample when the reference sample was predicted using intra-block copy mode prediction without using any inter-predicted samples.

5. The method of claim 1, wherein the current coding unit is encoded without using the reference sample when the reference sample was predicted using intra-block copy mode prediction using at least one inter-predicted samples

6. The method of claim 1, further comprising:
constraining prediction of the current coding unit to using only intra-predicted samples based on the constrained intra-prediction mode being enabled.

7. The method of claim 1, wherein the reference sample was predicted using chroma or luma interpolation.

8. The method of claim 1, wherein the one or more reference samples are determined from a previously encoded region of the picture.

9. A video encoding device for encoding video data, comprising:
a memory configured to store video data; and
a processor configured to:
obtain video data at an encoding device, the video data including a plurality of pictures;
determine a current coding unit for a picture from the plurality of pictures;
determine that constrained intra-prediction mode is enabled for the current coding unit;
encode the current coding unit using one or more reference samples, wherein the one or more reference samples are determined based on whether a reference sample has been predicted using intra-block copy mode prediction without using any inter-predicted samples, wherein, when the reference sample is predicted using intra-block copy mode without using any inter-predicted samples, the reference sample is available for predicting the current coding unit, and wherein, when the reference sample is predicted using intra-block copy mode using at least one inter-predicted sample, the reference sample is not available for predicting the coding unit.

10. The video encoding device of claim 9, wherein the processor is further configured to:
assign a first type to the reference sample when the reference sample was predicted using intra-block copy mode prediction without using any inter-predicted samples; and
assign a second type to the reference sample when the reference sample was predicted using intra-block copy mode prediction using at least one inter-predicted sample.

11. The video encoding device of claim 9, wherein the processor is further configured to:
use the current coding unit as a prediction block to predict another coding unit based, wherein the current coding unit is used based on the reference sample having been predicted using intra-block copy mode prediction without using any inter-predicted samples.

12. The video encoding device of claim 9, wherein the current coding unit is encoded using the reference sample when the reference sample was predicted using intra-block copy mode prediction without using any inter-predicted samples.

13. The video encoding device of claim 9, wherein the current coding unit is encoded without using the reference sample when the reference sample was predicted using intra-block copy mode prediction using at least one inter-predicted samples

14. The video encoding device of claim 9, wherein the processor is further configured to:
constraining prediction of the current coding unit to using only intra-predicted samples based on the constrained intra-prediction mode being enabled.

15. The video encoding device of claim 9, wherein the reference sample was predicted using chroma or luma interpolation.

16. The video encoding device of claim 9, wherein the one or more reference samples are determined from a previously encoded region of the picture.

17. A method for decoding video data, comprising:
obtaining video data at a decoding device, the video data including a plurality of pictures;
determining a current coding unit for a picture from the plurality of pictures;
determining that constrained intra-prediction mode is enabled for the current coding unit; and
identifying the current coding unit as predicted using intra-block copy, wherein decoding the current coding unit includes using intra-predicted samples.

18. The method of claim 17, further comprising:
determining that the current coding unit is a bi-predicted coding unit, wherein current coding unit is predicted using a first reference picture and a second reference picture;
determining that the first reference picture is the same as the picture; and
determining that the second reference picture is the same as the picture;
wherein the current coding unit is identified as predicted using intra-block copy based on the first reference picture and the second reference picture being the same as the picture.

19. The method of claim 17, further comprising:
determining that the current coding unit is a bi-predicted coding unit, wherein current coding unit is predicted using a first reference picture and a second reference picture;
determining that the first reference picture is the same as the picture; and
determining that the second reference picture is different from the picture;
wherein the current coding unit is converted from bi-predicted to uni-predicted based on the first reference picture being the same as the picture and the second reference picture being different than the picture.

20. The method of claim 19, further comprising:
discarding the second reference picture as a reference.
